(19) United States
(12) Patent Application Publication
(10) Pub. No.: US 2016/0095357 A1
(43) Pub. Date: Apr. 7, 2016

(54) ELECTRONIC VAPING DEVICE AND COMPONENTS THEREOF

(71) Applicant: Douglas A. BURTON, Glen Allen, VA (US)

(72) Inventor: Douglas A. BURTON, Glen Allen, VA (US)

(21) Appl. No.: 14/873,433

(22) Filed: Oct. 2, 2015

Related U.S. Application Data
(60) Provisional application No. 62/059,443, filed on Oct. 3, 2014.

(51) Int. Cl. A24F 47/00; F22B 1/28; H05B 3/44; B23P 19/00; H05B 1/02

(52) U.S. Cl. CPC A24F 47/008; B23P 19/00; H05B 1/0297; H05B 3/44; F22B 1/284

(57) ABSTRACT

A cartridge of an electronic vaping device includes an outer housing extending in a longitudinal direction, an air inlet, a vapor outlet, and an inner tube within the outer housing defining a central air passage that communicates with the air inlet and the vapor outlet. A reservoir including a pre-vapor formulation is in an annular space between the outer housing and the inner tube. A gasket is disposed in the outer housing of the cartridge. The gasket includes a base with a central orifice extending through the base and a circumferential projection including a guide surface on an inner surface of the projection. The central orifice is in communication with the central air passage. A portion of the inner tube is positioned within the guide surface, and no portion of the guide surface extends into the inner tube. The gasket seals an end of the reservoir.

### PRIORITY STATEMENT

This application is a non-provisional application that claims priority to U.S. provisional app. No. 62/059,443, filed on Oct. 3, 2014, the entire contents of which is incorporated by reference in its entirety.

### BACKGROUND OF THE INVENTION

1. Field

The present disclosure relates to electronic vaping devices including reservoirs including gaskets.

2. Description of Related Art

Electronic vaping devices may include a first section coupled to a second section via a threaded connection. The first section may be a replaceable cartridge, and the second section may be a reusable fixture. The first section may include a reservoir containing a pre-vapor formulation. A wick draws the pre-vapor formulation from the reservoir towards a heater that heats the pre-vapor formulation to a temperature sufficient to vaporize the pre-vapor formulation.

### SUMMARY

At least one example embodiment relates to a cartridge of an electronic vaping device.

In at least one example embodiment, the cartridge of an electronic vaping device includes an outer housing extending in a longitudinal direction, an air inlet, a vapor outlet, an inner tube within the outer housing defining a central air passage which communicates with the air inlet and the vapor outlet, a reservoir including a pre-vapor formulation in an annular space between the outer housing and the inner tube, and a gasket within the outer housing of the cartridge. The gasket includes a base with a central orifice extending through the base and a circumferential projection including a guide surface on an inner surface of the projection. The central orifice is in communication with the central air passage. A portion of the inner tube is positioned within the guide surface, no portion of the gasket extending into the inner tube. The gasket seals an end of the reservoir.

In at least one example embodiment, the gasket has an outer diameter of about 7 mm to about 8 mm and the central orifice has a diameter of about 2.0 mm to about 3.0 mm. The guide surface may be a frustoconical surface that declines from a top surface of the guide surface to the base. A portion of the base extends inwardly from the guide surface, and the base abuts the second end of the inner tube. In at least one example embodiment, the guide surface may include a cylindrical surface longitudinally extending from the base of the gasket, and a frustoconical surface extending outwardly from the cylindrical surface at an angle of about 20 degrees to about 80 degrees. The base may extend perpendicular to the longitudinal direction of the outer housing. In at least one example embodiment, the guide surface is a bowl-shaped surface adjacent the base which extends outwardly from a central axis of the central orifice of the gasket.

In at least one example embodiment, the cartridge may include a mouth-end insert. A surface of the mouth-end insert mates with a surface of the gasket, and the mouth-end insert includes the vapor outlet. The gasket may include a tubular body extending from the base opposite of the projection and towards a second end of the electronic vaping device. The tubular body abuts a surface of the mouth-end insert. The mouth-end insert may be a multi-port, mouth-end insert configured to distribute vapor throughout a mouth of an adult vapor drawing thereupon.

In at least one example embodiment, the gasket has a maximum thickness in the longitudinal direction of the outer housing ranging from about 1.5 mm to about 2.5 mm and a minimum thickness in the longitudinal direction of about 0.1 mm to about 1 mm. The gasket is formed of an elastic material. The elastic material may be poly(dimethylsiloxane). The central orifice has a diameter that is about ¼ to about ½ of an outer diameter of the gasket.

In at least one example embodiment, a cartridge of an electronic vaping device, the cartridge includes an outer housing extending in a longitudinal direction, an air inlet, a vapor outlet, an inner tube within the outer housing defining a central air passage which communicates with the air inlet and the vapor outlet, the inner tube having a first end and a second end, a reservoir including a pre-vapor formulation in an annular space between the outer housing and the inner tube, and a gasket within the outer housing of the cartridge. The gasket includes a base with a central orifice extending through the base, the base including a portion extending generally perpendicular to a longitudinal axis of the cartridge, and a circumferential projection including a guide surface on an inner surface of the projection, the guide surface being a frustoconical surface that declines a top surface of the projection to the base, the central orifice in communication with the central air passage, portion of the inner tube being positioned within the guide surface, and the gasket sealing an end of the reservoir.

At least one example embodiment relates to a method of making a cartridge of an electronic vaping device.

In at least one example embodiment, the method includes inserting a gasket into an outer housing of a cartridge, such that a central orifice of the gasket communicates with a central air passage of an inner tube within the outer housing, An end of the inner tube is disposed within a guide surface of the gasket, and no portion of the gasket extends into the inner tube. The gasket seals an end of a reservoir in an annular space between the outer housing and the inner tube.

In at least one example embodiment, the inserting of the gasket includes centering the inner tube within the outer housing with the guide surface of the gasket. The method may also include inserting a mouth-end insert into the outer housing of the cartridge such that a surface of the mouth-end insert abuts with a surface of the gasket.

In at least one example embodiment, a method of centering a misaligned inner tube in a cartridge of an electronic vaping device includes inserting a gasket into a longitudinally extending outer housing of the cartridge including a misaligned inner tube therein. A guide surface of the gasket aligns the inner tube within the longitudinally extending outer housing during insertion of the gasket. The method may include sealing a reservoir in an annular space between the outer housing and the inner tube with the gasket. The method may also include inserting a mouth-end insert into the outer housing of the cartridge, such that a surface of the mouth-end insert mates with a surface of the gasket.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a side view of an electronic vaping device according to at least one example embodiment.

FIG. 2 is a cross-sectional side view of a cartridge of an electronic vaping device according to at least one example embodiment.

FIG. 3A is a cross-sectional exploded view of a cartridge including a currently available seal of an electronic vaping device.

FIG. 3B is a cross-sectional view of an orifice of a currently available seal before insertion into an outer housing of a cartridge having a misaligned inner tube.

FIG. 3C is a cross-sectional view of an orifice of a currently available seal after insertion into an outer housing of a cartridge having a misaligned inner tube.

FIG. 4A is a cross-sectional exploded view of a cartridge of an electronic vaping device according to at least one example embodiment.

FIG. 4B is a planar view of a gasket according to at least one example embodiment.

FIG. 5A is a cross-sectional exploded view of a cartridge of an electronic vaping device according to at least one example embodiment.

FIG. 5B is a cross-sectional view of an orifice of a gasket before insertion into an outer housing of a cartridge having a misaligned inner tube.

FIG. 5C is a cross-sectional view of an orifice of a gasket after insertion into an outer housing of a cartridge having a misaligned inner tube.

FIG. 6 is a cross-sectional view of a cartridge of an electronic vaping device according to at least one example embodiment disclosed herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

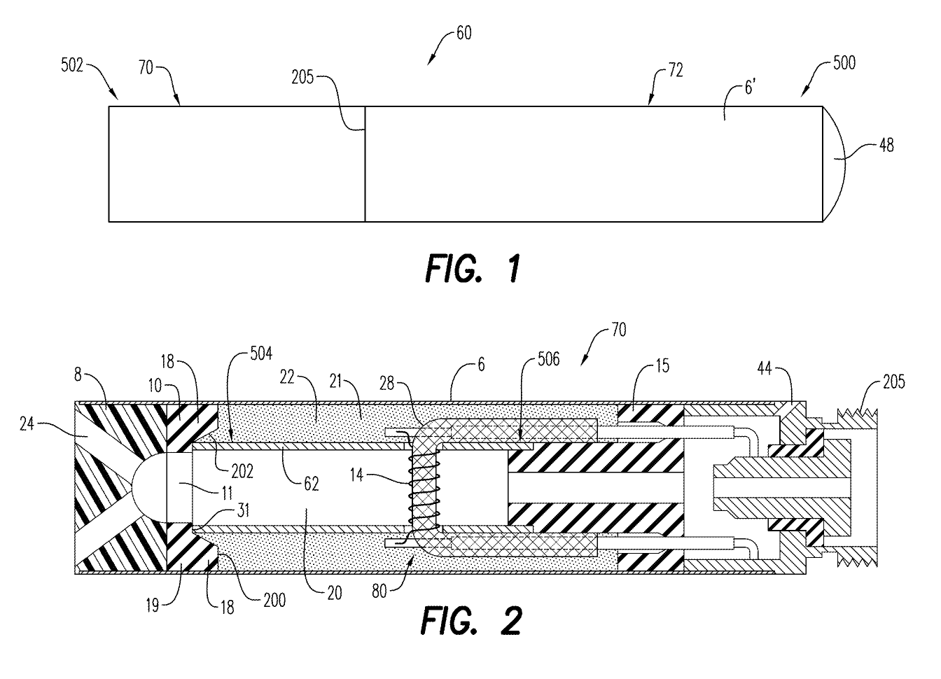

FIG. 1 is a side view of an electronic vaping device according to at least one example embodiment.

Referring to FIG. 1, in at least one example embodiment, the electronic vaping device 60 includes a cartridge (reservoir containing component) 70 and a reusable battery section (power supply containing component) 72. The cartridge 70 is disposable wherein the cartridge 70 is connectable to the reusable battery section 72 at a connection 205 such as a threaded connection or by another convenience such as a snug-fit, detent, clamp, clasp, and/or magnetic connection. Upon closure of the connection 205, the cartridge 70 is configured to generate vapor when powered by the battery section 72 during operation of the electronic vaping device 60. The battery section may include a light emitting diode (LED) 48 at an up an end thereof which is configured to glow (light up) during operation of the electronic vaping device 60. In at least one example embodiment, the battery section 72 may be disposable and the cartridge 70 and battery section 72 may be formed from a common uniform housing.

In at least one example embodiment, the electronic vaping device 60 is about the same size as a cigarette. In at least one example embodiment, the electronic vaping device 60 may be about 80 mm to about 110 mm long, or about 80 mm to about 100 mm long and up to about 10 mm or greater in diameter. For example, in at least one example embodiment, the electronic vaping device is about 84 mm long and has a diameter of about 7.8 mm. In an alternate example embodiment, the electronic vaping device 60 may be in a size and form approximating a cigar or a pipe.

In at least one example embodiment, the battery section 72 includes an outer housing 6′ (second outer housing) extending in a longitudinal direction and includes the battery or power source (not shown), in electrical communication with the vaporizer (not shown) of the cartridge 70 upon closure of the connection 205 through LED 48, a puff sensor (not shown), and control circuitry (not shown). In at least one example embodiment, the battery section 72 includes a puff sensor and a control circuit as described in commonly-assigned U.S. Patent Application No. 2014/0238423 which is incorporated by reference herein in its entirety by reference thereto.

FIG. 2 is a cross-sectional side view of a cartridge of an electronic vaping device according to at least one example embodiment.

Referring now to FIG. 2, the cartridge 70 includes an outer housing 6 extending in a longitudinal direction, an air inlet 44, a vapor outlet 24, and an inner tube (chimney) 62 within the outer housing 6. The inner tube 62 defines a central air passage 20 that communicates with the air inlet 44 and the vapor outlet 24. A reservoir 22 including a pre-vapor formulation therein may be formed in an annular space between the outer housing 6 and the inner tube 62.

The outer housing 6 and/or the inner tube 62 may be formed of any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK), ceramic, and polyethylene. The material is light and non-brittle.

A pre-vapor formulation is a material or combination of materials that may be transformed into a vapor. For example, the pre-vapor formulation may be a liquid, solid, and/or gel formulation including, but not limited to, water, beads, solvents, active ingredients, ethanol, plant extracts, natural or artificial flavors, and/or vapor formers, such as glycerine and propylene glycol.

The pre-vapor formulation has a boiling point suitable for use in the electronic vaping device 60. If the boiling point is too high, the heater 14 will not be able to vaporize pre-vapor formulation in the wick 28. However, if the boiling point is too low, the pre-vapor formulation may vaporize prematurely without the heater 14 being activated.

In at least one example embodiment, the annular space of the reservoir 22 is sealed at a first end 506 by a seal 15 and at a second end 504 by a gasket 10 so as to reduce and/or substantially prevent pre-vapor formulation from within the reservoir 22 from leaking into the central air passage 20. The gasket 10 may further prevent and/or reduce pre-vapor formulation from reaching the mouth-end insert 8.

In at least one example embodiment, the gasket 10 includes a central orifice 11 in communication with the central air passage 20 defined by the inner tube 62. The dimensions of the central orifice 11 (i.e., the diameter and length thereof) control the flow rate of vapor exiting the central air passage 20 and entering the mouth-end insert 8. The gasket 10 includes a projection 18 and a guide surface 202 thereof surrounding the central orifice 11. The guide surface 202 converges from the top surface 200 of the projection 18 toward a first end 504 of the inner tube 62. When the gasket 10 is inserted in the outer housing 6, a portion of the inner tube 62 is disposed within the guide surface 202 and the projection 18 of the gasket 10, and no portion of the gasket 10 is inserted in the inner tube 62. Thus, the characteristics of the airflow through the central orifice 11 of the gasket 10 will not be altered by a misaligned inner tube 62.

In at least one example embodiment, the reservoir 22 contains the pre-vapor formulation, and optionally, a storage medium 21 (e.g., fibrous medium) configured to disperse and/or regulate a flow of the pre-vapor formulation in the reservoir 22. For example, the storage medium 21 may be a wrapping of gauze about the inner tube 62. The storage medium 21 comprises an outer wrapping of gauze surrounding an inner wrapping of gauze of the same or different material. In at least one example embodiment, the storage medium 21 of the reservoir 22 is constructed from an alumina ceramic in the form of loose particles, loose fibers, or woven or nonwoven fibers, or alternatively the storage medium 21 is constructed from a cellulosic material such as cotton or gauze material or polymer material, such as polyethylene terephthalate in the form of a bundle of loose fibers.

In at least one example embodiment, the storage medium 21 may comprise a fibrous material comprising cotton, polyethylene, polyester, rayon and combinations thereof. The fibers have a diameter ranging in size from about 6 microns to about 15 microns (e.g., about 8 microns to about 12 microns or about 9 microns to about 11 microns). The storage medium 21 may be a sintered, porous, or foamed material. The fibers are sized to be irrespirable and may have a cross-section which has a y-shape, cross shape, clover shape or any other suitable shape. In other example embodiments, the reservoir 22 may comprise a filled tank lacking a storage medium 21.

As shown in FIG. 2, in at least one example embodiment, the cartridge 70 may include a vaporizer 80, which is configured to form a vapor when the vaporizer 80 is powered by a battery or power source (not shown) of the battery section 72 (see FIG. 1) of the electronic vaping device 60. In at least one example embodiment, the vaporizer 80 may include a wick 28 and a heater 14 in thermal communication with the wick 28. In some example embodiments, the heater 14 may be a wire coil that surrounds the wick 28. The wick 28 may be in communication with the reservoir 22 and is configured to draw pre-vapor formulation from the reservoir 22 toward the heater 14. The heater 14 is in electrical communication with the battery of the battery section 72 upon closure of the connection 205 such that the heater 14 is configured to heat the pre-vapor formulation wicked to the heater 14 to a temperature sufficient to vaporize the pre-vapor formulation.

In at least one example embodiment, the wick 28 is constructed of a flexible, filamentary material. The wick 28 comprises a plurality of filaments having sufficient capillarity via interstitial spaces between the filaments to draw pre-vapor formulation from the reservoir 22 toward the heater 14. The wick 28 may comprise a bundle of glass, ceramic, or metal filaments or windings of filaments wound together into separate bundles or strands. In at least one example embodiment, the wick 28 comprises a plurality of bundles, such as three or more bundles or strands of wound fiberglass filaments. In some example embodiments, the wick 28 may be a porous body.

The wick 28 may include filaments having a cross-section which is generally cross-shaped, clover-shaped, Y-shaped, or in any other suitable shape.

In at least one example embodiment, the wick 28 includes any suitable material or combination of materials. Examples of suitable materials are glass filaments, fiberglass filaments, and ceramic, metal, or graphite based materials. Moreover, the wick 28 may have any suitable capillarity to accommodate pre-vapor formulations having different physical properties such as density, viscosity, surface tension, and vapor pressure. The capillarity properties of the wick 28 and the properties of the pre-vapor formulation are selected such that the wick 28 is always wet, while any pre-vapor formulation remains in the reservoir 22, in the area adjacent the heater 14 to avoid overheating of the heater 14 and/or the wick 28.

In at least one example embodiment, the heater 14 may be a wire coil which at least partially surrounds the wick 28. The wire coil may extend fully or partially around the circumference of the wick 28 with or without spacing between the turns of the coil. Alternatively, the heater 14 may not be in contact with the wick 28. In at least one example embodiment, the heater 14 is located adjacent to the wick 28 wherein the heater 14 is configured to heat the wick 28 to a temperature sufficient to vaporize the pre-vapor formulation on the wick 28 and form a vapor through convection.

In at least one example embodiment, one or two air inlets 44 communicate with the central air passage 20. Alternatively, there may be three, four, five or more air inlets 44. If there are more than two air inlets, the air inlets 44 are located at different locations along the length and/or around the circumference of the electronic vaping device 60. Further, altering the size and number of air inlets 44 may also aid in establishing a desired resistance to draw of the electronic vaping device 60, and reduce generation of a whistling noise during a draw on the electronic vaping device 60.

The cartridge 70 further includes a mouth-end insert 8 having two or more, off-axis, diverging outlets 24 or four outlets 24. In at least one example embodiment, a mouth-end insert 8 may be found in commonly-assigned U.S. Patent Application No. 2013/0192615 which is incorporated by reference herein in its entirety. Alternatively, the multi-port mouth-end insert 8 may have a single outlet 24. The multi-port mouth-end insert 8 is in fluid communication with the central air passage 20 defined by the interior of inner tube 62.

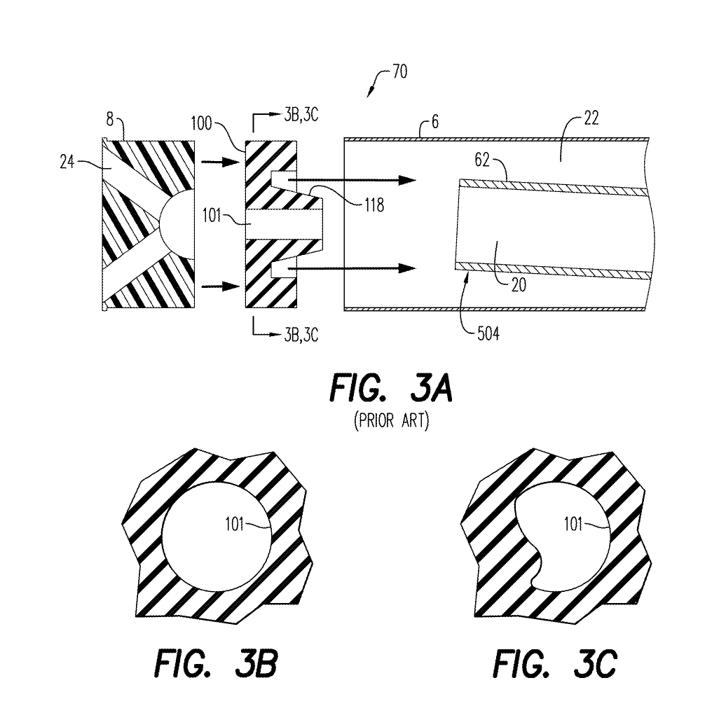

FIG. 3A is a cross-sectional exploded view of a cartridge including a prior art seal of an electronic vaping device.

As shown in FIG. 3A, the prior art seal 100 may be inserted into the outer housing 6 of the cartridge so as to seal an end of the reservoir 22 defined in the annular space between the inner tube 62 and the outer housing 6. As shown, the prior art seal 100 includes a nose 118 which is inserted into the central air passage 20 of the inner tube 62. An orifice 101 extends through the nose 118 of the prior art seal 100 and communicates with the central air passage 20. If the inner tube 62 of the cartridge 70 is misaligned within the longitudinally extending outer housing 6 of the cartridge 70 during insertion of the prior art seal 100, the misaligned inner tube 62 will often distort (deform) the nose 118 and the orifice 101 of the prior art seal 100. In essence, the prior art seal 100 centers the inner tube 62 by contacting outer surfaces of the nose 118 with inner, upper edge portions of the inner tube 62. Any resultant deflection of the outer surfaces of the nose 118 is directed toward the orifice 101.

FIG. 3B is a cross-sectional view of an orifice of a currently available seal before insertion into an outer housing of a cartridge having a misaligned inner tube.

As shown in FIG. 3B, the orifice 101 of a prior art seal 100 before insertion into the outer housing 6 of a cartridge 70 having a misaligned inner tube 62, the orifice 101 is not deformed.

FIG. 3C is a cross-sectional view of an orifice of a currently available seal after insertion into an outer housing of a cartridge having a misaligned inner tube. As shown in FIG. 3C, the orifice 101 of a prior art seal 100 after insertion into an outer housing 6 of a cartridge 70 having the misaligned inner tube 62 is deformed (i.e., radial deflection causing the orifice 101 to be non-concentric) due to contact between the flexible nose 118 of the prior art seal 100 and the misaligned inner tube 62. The deformation, as shown, restricts the area of the orifice 101, and thus increases air speed through the orifice 101. The deformed orifice 101 may also cause vapor to not be evenly distributed through the vapor outlets 24 of the multi-port mouth-end insert 8, thereby causing non-uniform distribution of vapor into the mouth of an adult vaper vaping the electronic vaping device 60.

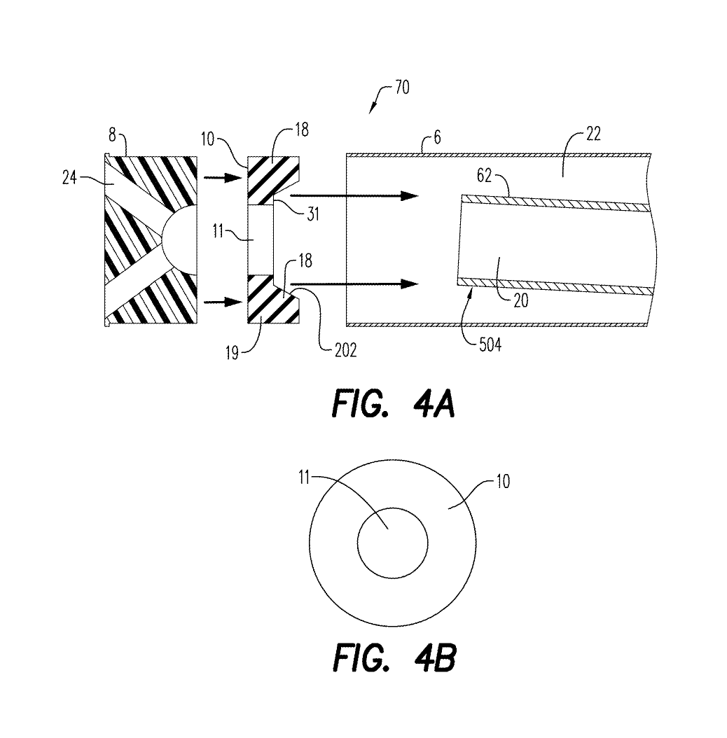

FIG. 4A is a cross-sectional exploded view of a cartridge of an electronic vaping device according to at least one example embodiment. In at least one example embodiment, as shown in FIG. 4, instead of the prior art seal 100, the gasket 10 is inserted into the housing 6 to seal the reservoir 22. As shown in FIG. 4A, the gasket 10 does not include a nose portion, thus no portion of the gasket 10 is inserted into the inner tube 62. Instead, the gasket 10 has a generally c-shaped cross-section declining from a circumferential projection 18 to a base 19. The base 19 is generally ring-shaped with the central orifice 11 extending therethrough. The projection 18 is also generally ring-shaped, and may have a same outer diameter as the base 19. An inner diameter of the central orifice 11 may be smaller than an inner diameter of the inner tube 62. The projection 18 may include a guide surface 202. An inner diameter of the guide surface 202 of the projection 18 may increase from the base 19 to a top surface 200 of the projection 18. The guide surface 202 is angled outwardly with respect to a longitudinal axis of the electronic vaping device 60 so as to be easily insertable into a space between the inner tube 62 and the outer housing 6.

In at least one example embodiment, an outer periphery of the gasket 10 may include rounded and/or beveled edges (not shown) to facilitate the insertion of the gasket 10 into the outer housing 6.

In at least one example embodiment, the outer surface of the gasket 10 forms a seal with the inner surface of the outer housing 6. The seal may substantially prevent leakage of the pre-vapor formulation from the reservoir 22. The gasket 10 is formed of a flexible (elastic) material, such as poly(dimethylsiloxane).

In at least one example embodiment, the gasket 10 includes a portion (rim or flange) 31 defining the central orifice 11. The portion 31 may be a portion of the base 19 that extends inwardly from the guide surface 202 of the gasket 10. In at least one example embodiment, the portion 31 may extend inwardly from the guide surface 202 at an angle perpendicular to the longitudinal direction of the outer housing 6. The portion 31 may extend slightly upward and/or downward from the perpendicular angle of the longitudinal direction of the outer housing 6. The portion 31 may extend about ±10 degrees upward and/or downward from the perpendicular angle of the longitudinal direction of the outer housing 6, or about ±5 degrees upward and/or downward from the perpendicular angle of the longitudinal direction of the outer housing 6. The second end 504 of the inner tube 62 mates with and/or abuts a surface of the portion 31 so as to form a seal. The seal substantially prevents and/or reduces pre-vapor formulation from leaking from the reservoir 22 and entering the central air passage 20 defined by the inner tube 62. In at least one example embodiment, the guide surface 202 may be a generally frustoconical surface adjacent the portion 31, which extends outwardly from a central axis of the central orifice 11 of the gasket 10 at an angle of about 20 degrees to about 80 degrees.

In at least one example embodiment, the portion 31 may have a thickness of about 0.3 mm to about 1.5 mm, an inner diameter of about 2.0 mm to about 3.0 mm and an outer diameter of about 4.0 mm to about 5.0 mm.

FIG. 4B is a planar view of a gasket according to at least one example embodiment. As shown in FIG. 4B, the gasket 10 is generally ring-shaped and includes the central orifice 11 that is generally circular or elliptical.

In at least one example embodiment, the gasket 10 may have an outer diameter of about 7 mm to about 8 mm and the central orifice 11 may have a diameter of about 2.0 mm to about 3.0 mm. In at least one example embodiment, the central orifice 11 may have a diameter of about ¼ to about ½ the diameter of the gasket 10. In at least one example embodiment, the gasket 10 may have a maximum thickness in the longitudinal direction of the outer housing 6 of about 1.5 mm to about 2.5 mm and a minimum thickness in the longitudinal direction of about 0.1 mm to about 1 mm.

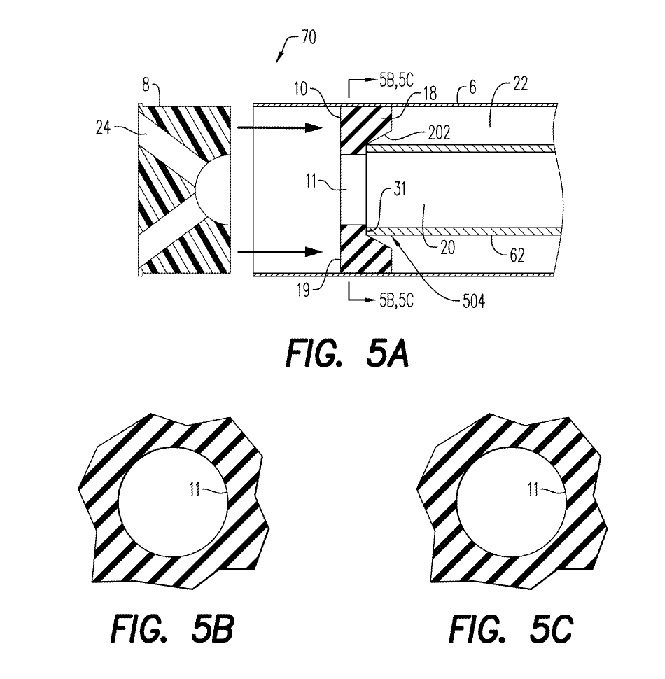

FIG. 5A is a cross-sectional exploded view of a cartridge of an electronic vaping device according to at least one example embodiment.

In at least one example embodiment, as shown in FIG. 5A, the gasket 10 is the same as in FIG. 4A, except that the gasket 10 is shown inserted into the outer housing 7. As shown in FIG. 5A, the gasket 10 includes the central orifice 11 that is not deformed when the gasket 10 is inserted into the outer housing 6 and inner tube 62 is misaligned as shown. The gasket 10 may be inserted into the outer housing 6 of the cartridge 70 so as to seal an end of the reservoir 22 defined in an annular space between the inner tube 62 and the outer housing 6. The guide surface 202 converges towards a second end 504 of the inner tube 62 and surrounds the inner tube 62 upon insertion, such that the guide surface 202 is configured to align (center) the inner tube 62 within the outer housing 6 if the inner tube 62 is misaligned within the outer housing 6 prior to insertion of the gasket 10.

As shown in FIG. 5A, after the gasket 10 has been put into place in the outer housing 6 of the cartridge 70, the misaligned inner tube 62 of FIG. 4A is aligned (centered) in the outer housing 6 of the cartridge 70 by the guide surface 202 of the gasket 10 during the centering process. No portion of the gasket 10 extends into the inner tube 62.

FIG. 5B is a cross-sectional view of an orifice of a gasket before insertion into an outer housing of a cartridge having a misaligned inner tube. As shown in FIG. 5B, before insertion into the outer housing 6 of a cartridge 70 having a misaligned inner tube 62, the central orifice 11 is not deformed.

FIG. 5C is a cross-sectional view of an orifice of a gasket after insertion into an outer housing of a cartridge having a misaligned inner tube. As shown in FIG. 5C, after insertion of the gasket 10 into the outer housing 6 of the cartridge 70 having the misaligned inner tube 62, the central orifice 11 is not deformed. Accordingly, the problems of increased airflow through the central orifice 11, and uneven distribution of vapor through the central orifice is lessened or avoided by use of the gasket 10 as described herein. Further, the guide surface 202 of the gasket aligns (centers) the inner tube 62 within the outer housing 6, thus reducing the cost of manufacture of the cartridge 70 and the likelihood of manufacturing error. After the gasket 10 has been inserted into the outer housing 6, the mouth-end insert 8 may be inserted into the outer housing 6.

In at least one example embodiment, even if the gasket 10 does not align or fully align the misaligned inner tube 62 within the central housing 6 of the cartridge, the insertion of the gasket 10 into the outer housing 6 will not cause the central orifice 11 to distort because the radial force applied by the misaligned inner tube 62 will be absorbed by the guide surface 202 (by deflection) in a direction radially away from the central orifice 11. Thus, even though the inner tube 62 does not fully align within the outer housing 6, the central orifice 11 will not be distorted by the misaligned inner tube 62 and the problems of increased airflow through the central orifice 11, and uneven distribution of vapor through the central orifice 11 and the mouth-end insert 8 will be reduced and/or avoided.

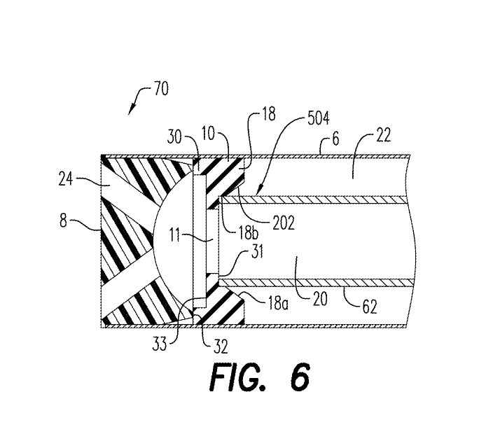

FIG. 6 is a cross-sectional view of a cartridge of an electronic vaping device according to at least one example embodiment disclosed herein.

In at least one example embodiment, as shown in FIG. 6, the gasket 10 is the same as the gasket in FIG. 2 except that the bottom surface 33 of the gasket 10 includes a tubular body 30, which mates with a surface 32 of the mouth-end insert 8, and the guide surface 202 includes a longitudinally extending cylindrical surface 18b adjacent the portion 31 and a frustoconical surface 18a extending outwardly from the cylindrical surface 18b at an angle of about 10 degrees to about 80 degrees. The cylindrical surface 18b of the guide surface 202 is sized and configured to contact and hold the second end 504 of the inner tube 62 therein. In at least one example embodiment, the guide surface 202 may be a bowl-shaped (arcuate) surface adjacent the portion 31, which extends outwardly from a central axis of the central orifice 11 of the gasket 10. In at least one example embodiment, the second end 504 of the inner tube 62 may mate with the frustoconical surface 18a of the guide surface 202 so as to form a seal therebetween. In at least one example embodiment, an outer periphery of the second end 504 of the inner tube 62 may mate with the cylindrical surface 18b so as to form a seal therebetween. In at least one example embodiment, the gasket 10 may not include the portion 31 extending inwardly of the guide surface.

In at least one example embodiment, as shown in FIG. 6, the mouth-end insert 8, which is at the second end 502 of the electronic vaping device 60, may include a surface (rim) 32 that mates and/or abuts with a bottom surface (rim) 33 of the gasket 10.

In at least one example embodiment, the gasket 10 may not include the portion 31 (not shown).

Whereas the example embodiments are described as being cylindrical, other suitable forms include right angular, triangular, oval, oblong, or other cross-sections.

“Electronic vaping device(s)” is intended to be inclusive of electronic cigarettes, cigars, hookahs, pipes, and the like.

When the word “about” is used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages.

Moreover, when the words “generally” and “substantially” are used in connection with geometric shapes, it is intended that precision of the geometric shape is not required but that latitude for the shape is within the scope of the disclosure.

It will now be apparent that a new, improved, and nonobvious electronic vaping device has been described in this specification with sufficient particularity as to be understood by one of ordinary skill in the art. Moreover, it will be apparent to those skilled in the art that modifications, variations, substitutions, and equivalents exist for features of the electronic vaping device which do not materially depart from the spirit and scope of the embodiments disclosed herein. Accordingly, it is expressly intended that all such modifications, variations, substitutions, and equivalents which fall within the spirit and scope of the invention as defined by the appended claims shall be embraced by the appended claims.

We claim:

1. A cartridge of an electronic vaping device, the cartridge comprising:
an outer housing extending in a longitudinal direction;
an air inlet;
a vapor outlet;
an inner tube within the outer housing defining a central air passage which communicates with the air inlet and the vapor outlet, the inner tube having a first end and a second end;
a reservoir including a pre-vapor formulation in an annular space between the outer housing and the inner tube; and
a gasket within the outer housing of the cartridge, the gasket including,
a base with a central orifice extending through the base, and
a circumferential projection including a guide surface on an inner surface of the projection, the central orifice in communication with the central air passage, a portion of the inner tube being positioned within the guide surface, no portion of the gasket extending into the inner tube, and the gasket sealing an end of the reservoir.

2. The cartridge of claim 1, wherein the gasket has an outer diameter of about 7 mm to about 8 mm and the central orifice has a diameter of about 2.0 mm to about 3.0 mm.

3. The cartridge of claim 1, wherein the guide surface is a frustoconical surface that declines from a top surface of the guide surface to the base.

4. The cartridge of claim 3, wherein a portion of the base extends inwardly from the guide surface, and the base abuts the second end of the inner tube.

5. The cartridge of claim 1, wherein the guide surface comprises:
a cylindrical surface longitudinally extending from the base of the gasket; and
a frustoconical surface extending outwardly from the cylindrical surface at an angle of about 20 degrees to about 80 degrees.

6. The cartridge of claim 4 wherein the base extends perpendicular to the longitudinal direction of the outer housing.

7. The cartridge of claim 3, wherein the guide surface is a bowl-shaped surface adjacent the base which extends outwardly from a central axis of the central orifice of the gasket.

8. The cartridge of claim 1, further comprising:
a mouth-end insert including a first surface mating with the base of the gasket, the mouth-end insert including the vapor outlet.

9. The cartridge of claim 8, wherein the gasket further comprises:
a tubular body extending from the base opposite the projection, the tubular body abutting the first surface of the mouth-end insert.

10. The cartridge of claim 8, wherein the mouth-end insert is a multi-port, mouth-end insert configured to distribute vapor throughout a mouth of an adult vapor.

11. The cartridge of claim 1, wherein the gasket has a maximum thickness in the longitudinal direction of the outer housing ranging from about 1.5 mm to about 2.5 mm and a minimum thickness in the longitudinal direction of about 0.1 mm to about 1 mm.

12. The cartridge of claim 1, wherein the gasket is fog flied of an elastic material.

13. The cartridge of claim 12, wherein the elastic material is poly(dimethylsiloxane).

14. The cartridge of claim 1, wherein the central orifice has a diameter that is about ¼ to about ½ of a diameter of the gasket.

15. A cartridge of an electronic vaping device, the cartridge comprising:
an outer housing extending in a longitudinal direction;
an air inlet;
a vapor outlet;
an inner tube within the outer housing defining a central air passage which communicates with the air inlet and the vapor outlet, the inner tube having a first end and a second end;
a reservoir including a pre-vapor formulation in an annular space between the outer housing and the inner tube; and
a gasket within the outer housing of the cartridge, the gasket including,
a base with a central orifice extending through the base, the base including a portion extending generally perpendicular to a longitudinal axis of the cartridge, and
a circumferential projection including a guide surface on an inner surface of the projection, the guide surface being a frustoconical surface that declines a top surface of the projection to the base, the central orifice in communication with the central air passage, portion of the inner tube being positioned within the guide surface, and the gasket sealing an end of the reservoir.

16. A method of making the cartridge of an electronic vaping device, the method comprising:
inserting a gasket into an outer housing of a cartridge such that a central orifice of the gasket communicates with a central air passage of an inner tube within the outer housing, an end of the inner tube is disposed within a guide surface of the gasket, no portion of the gasket extends into the inner tube, and the gasket seals an end of a reservoir in an annular space between the outer housing and the inner tube.

17. The method of claim 16, wherein the inserting of the gasket includes centering the inner tube within the outer housing with the guide surface of the gasket.

18. The method of claim 16, further comprising:
inserting a mouth-end insert into the outer housing of the cartridge, such that a surface of the mouth-end insert abuts with a surface of the gasket.

19. A method of centering a misaligned inner tube in a cartridge of an electronic vaping device, the method comprising:
inserting a gasket into a longitudinally extending outer housing of the cartridge including a misaligned inner tube therein, a guide surface of the gasket aligning the inner tube within the longitudinally extending outer housing during insertion of the gasket.

20. The method of claim 19, further comprising:
sealing a reservoir in an annular space between the outer housing and the inner tube with the gasket.

21. The method of claim 19, further comprising:
inserting a mouth-end insert into the outer housing of the cartridge, such that a surface of the mouth-end insert mates with a surface of the gasket.
